(19) United States
(12) Patent Application Publication
(10) Pub. No.: US 2024/0246388 A1
(43) Pub. Date: Jul. 25, 2024

(54) OPEN AIR VEHICLE OCCUPANT COOLING MIST APPARATUS

(71) Applicant: Mark Steven Beaird, Tucson, AZ (US)

(72) Inventor: Mark Steven Beaird, Tucson, AZ (US)

(21) Appl. No.: 18/412,529

(22) Filed: Jan. 14, 2024

Related U.S. Application Data
(60) Provisional application No. 63/439,090, filed on Jan. 14, 2023.

(51) Int. Cl. B60H 1/00; B60H 1/32

(52) U.S. Cl. CPC B60H 1/00407; B60H 1/3202

(57) ABSTRACT

The embodiments of the present invention are configured to cool the occupant(s) while operating an open-air vehicle, utilizing evaporative cooling, reducing the potential for potentially adverse heat related health conditions. The misting apparatus is comprised of a remote water reservoir, manually gas pressurized by a piston type pump. The apparatus is manually activated by depressing an integral normally closed, manually operated, momentary, push button on/off water control valve, incorporated into the water control manifold, between the pressurized water reservoir, and the misting nozzle manifolds. Water is supplied via a main water supply line, joined at the outlet side of the pressurized water reservoir, to the inlet side of the water control manifold. Depressing the push button on-off water control valve, water flows through the control valve. Thus, allowing pressurized water in the remote water reservoir to flow through the misting nozzle(s), contacting the occupants and utilizing the evaporative cooling effect.

### CROSS-REFERENCE TO RELATED APPLICATIONS

Provisional Application 63/439,090 Filed Jan. 14, 2023

### FEDERALLY SPONSORED RESEARCH AND DEVELOPMENT

N/A

### PRIOR ART

Ridgeway U.S. Pat. No. 7,458,528 B2 Invented a fluid misting apparatus to be attached to a cycle having an electrical energy source to run an electrically energized pump to operate the system. This method of cooling occupant(s) is efficient but adds complexity requiring attachment to an electrical source. It requires a complicated installation process, as well as added maintenance and expense of replacement parts.

Carozza U.S. Pat. No. 9,919,324 B2 Invented a bicycle mounted misting and hydration system, to cool and hydrate the cyclist during operation. Although Carozza's system is efficient, manually operated and does not require an energy source to operate. It is a trigger activated system, like a spray bottle and requires constant manual pumping to operate. Therefore, making it cumbersome to operate and mount on most on-road and off-road open-air vehicles.

Carozza U.S. Pat. No. 9,186,691 B2 Invented a variation of a bicycle mounted misting and hydration system, to cool and hydrate the cyclist during operation. Although Carozza's system is efficient, manually operated and does not require an energy source to operate, it is a lever activated system and requires constant manual pumping to operate. Therefore, making it cumbersome to operate and mount on most on-road and off-road open-air vehicles.

Peterson U.S. Pat. No. 10,603,984 B2 Invented an open-air cooling device and method for cooling occupant(s) in golf carts. Although efficient, it requires a complicated installation, and an electrical energy source to operate. The system operates on a prepayment vending payment system, to run an electrically energized pump to provide cooling.

Osborn U.S. Pat. No 9,657,727 B2 Invented a water amusement and hydration bicycle to cool and hydrate a cyclist during operation. This is a complete system built within the bicycle and requires a power source, to run an electrically energized pump or air compressor. Therefore, making it inefficient and a non-transferable application for on-road and off-road open-air vehicles.

### BACKGROUND OF THE INVENTION

Misting systems are utilized for in various configurations, for the purpose of cooling individuals, in settings, such as home patios, restaurants, and while enjoying other outdoor activities. Cooling of the individual(s) is achieved by utilizing atomized water, and the subsequent evaporative cooling effect, to regulate body temperature. It is commonly known that the atomization of water and the subsequent evaporative cooling effect can reduce the ambient temperature by 10 to 25 degrees depending on relative humidity. The cooling effect provides a more comfortable environment, and more enjoyable experience, as well as reducing the potential for possible adverse heat related health conditions. In view of the foregoing disadvantages in known evaporative cooling misting systems art, which pertain to open-air vehicles. The present disclosure provides a novel evaporative cooling mist apparatus, for occupant(s) operating, or riding in open air vehicles. The general purpose of the present disclosure will be described subsequently, in greater detail, pertaining to the embodiment of the open-air vehicle occupant cooling mist apparatus. The embodiments described in detail below are related to the field of fluid (e.g., water) atomization, for the purpose of utilizing the evaporative cooling effect for self-regulating body temperature. And therefore, cooling the occupant(s) while operating or riding in or on an open-air vehicle.

Individuals operating or riding in or on open air vehicles, can be exposed to excessive heat energy, via solar reflective heat, exposure to heat coming from the engine compartment, as well as reflective heat coming directly from the earth's surface.

Powersports enthusiasts, recreationists, as well as personnel preforming work, can be exposed to various heat sources. This exposure can be experienced while engaged in recreational activities or while performing work in an open-air vehicle without air conditioning systems.

Excessive heat exposure is associated with being uncomfortable and can lead to a loss of performance during recreational activities and productivity at work. An open-air vehicle occupant cooling mist apparatus attached directly to the open-air vehicle, can be utilized to self-regulate body temperature to a comfortable level. And reduce the potential for possible adverse heat related health conditions.

The open-air vehicle occupant cooling mist apparatus can be attached to a variety of open-air vehicles currently on the market. Attachment of the open-air cooling mist apparatus is directly to the handlebars, roll cages or awnings of open-air vehicles. Therefore, improving performance and enjoyment of power sports enthusiasts, recreationists, and elevating the productivity of work personnel. Utilization of the open-air vehicle occupant cooling mist apparatus allows the occupant(s) to regulate body temperature and creates a more conducive environment.

Typical misting systems either patented, or on the market today, pertaining to open-air vehicles, are operated primarily by a power source, or are trigger or lever operated much like a spray bottle. The disadvantage to these systems is the requirements of a power source, a more complicated installation process to operate, and are cumbersome by nature during operation. These systems also require regular maintenance, and or the expense of replacement parts.

Accordingly, the embodiments of the open-air vehicle occupant cooling mist apparatus address the existing deficiencies of open air vehicle cooling mist systems, currently patented or on the market.

### SUMMARY OF THE INVENTION

The primary objective of the preferred embodiment addresses the need to regulate body temperature, when exposed to solar reflective heat during warm or hot environments or other heat source exposure conditions. This in turn reduces the potential for adverse heat related health conditions. Powersports enthusiasts, recreationalists, and work personnel can utilize the preferred embodiment when operating open-air vehicles without air conditioning systems in place. Therefore, enjoying a more comfortable, safer environment during these activities.

The preferred embodiment objectives are as follows:
Improved self-regulation of body temperature, while operating, or riding in an open-air vehicle when exposed to excessive heat sources
Reduces the potential, for heat related adverse health conditions
Provides a more enjoyable, longer lasting experience, while operating an open-air vehicle, during recreational or work activities
Simplistic in nature to operate and function
Power source connections are not required
Integrates well with existing open-air vehicles currently on the market

The detachable, multi-function remote BPA free water reservoir can also be used for personal cooling, drinking, showering, and cleaning, when detached from the open-air vehicle.

Medical grade components are utilized in the composition of the apparatus, for proven longevity in the field, and hygienic operation

Provides a cost effective alternative cooling source for occupant(s) operating open-air vehicles, when air conditioning systems are not an option, or practical

### SPECIFICATION

The preferred embodiments of the open-air vehicle occupant cooling mist apparatus disclosed herein, are comprised of a water control manifold, and misting nozzle manifolds and their components, disclosed in further detail below. A multi-function, 32 oz BPA free water reservoir is a commercially available handheld personal misting unit and is utilized to complete the system as a whole. The water reservoir discussed in further detail is essential in understanding the utilization of the embodiments of the open-air vehicle cooling mist apparatus. The water reservoir has been adapted accordingly using two separate attachable devices, which make up the apparatus, a lid locking device, locking it in an open position, and a barbed screw on cap attachment that replaces the handheld units personal screw on misting nozzle, discussed in further detail below. The water reservoir is manually gas (e.g. air) pressurized, by a mechanical piston type pump, incorporated in the removable lid of the reservoir. The multi-function 32 oz BPA free water reservoir is operated by a pinch valve located below the lever type trigger. The pinch valve is normally closed, activation is accomplished by depressing the lever type trigger, located in the top section of the lid. The lid locking device locks the lever type trigger located on the lid to a normally open position. By manually operating the piston type pump located on the water reservoirs lid, therefore, the pump creates gas pressurization, and contacts the water in the remote water reservoir, the high pressure retaining capacity of the water reservoir equates approximately to city water pressure of 35 psi. The remote water reservoir when pressurized provides more than adequate water pressure to be utilized in conjunction with the open-air vehicle cooling mist apparatus. The remote water reservoir can be used in any position even upside down, by utilizing the integral weighted siphon, making it easily adaptable to various remote locations on or in the open air vehicle.

The commercially available water reservoir and screw on pump lid, have been adapted accordingly to be remotely located in conjunction with the preferred embodiment of the open-air vehicle cooling mist apparatus, by the use of two separate attachable devices. One, the water reservoir manufacturer provides a lid locking device, therefore keeping the normally closed pinch valve to a normally open position. The barbed screw on cap attachment, is an integral part of the embodiment of the open-air vehicle cooling mist apparatus. Thus, the attachment of the barbed screw on cap to the remote water reservoirs outlet side, allows for the connection of an extendable main water supply line and in conjunction with the lid locking device, allows the apparatus to be utilized as an open-air vehicle cooling mist apparatus. Pressurized water flows from the remote water reservoir, through the main water supply line, and is stopped at the integral, normally closed, manually operated, momentary, push button on-off water control valve, and activated by the depression of the water control valve, integral to the water control manifold, mounted to the open-air vehicle.

The barbed screw on cap attachment, connects the main water supply line, from the remote water reservoirs outlet side to the water control manifold inlet side. The main water supply line connects from the remote water reservoirs outlet side to a barbed, exhausting quick release coupling, for ease of removal and refilling the remote water reservoir. The barbed exhausting quick release coupling is located between the remote water reservoir and the water control manifold. The quick release coupling allows for draining, cleaning and winterization of the system. The main water supply line connects from the quick release coupling to a barbed reducing coupling, located forward, toward the water control manifold, on the main water supply line. The reduced main water supply line allows for greater pressurized water flow velocity, to the water control manifold's inlet side, making the apparatus more efficient, as the water gets divided among the misting nozzle manifolds when activated. The reduced main water supply line connects from the barbed reducing coupling to the barbed inlet side of the water control manifold. The water control manifold incorporates an integral normally closed, manually operated, momentary, push button, on-off water control valve. Activation is accomplished easily and safely by the depression of the water control valve. Activation allows pressurized water to flow over the valve, through the outlet side of the water control manifold, supplying pressurized water from the outlet side of the water control manifold to the water supply lines connected to the misting nozzle manifolds. Pressurized water from the water control manifold's outlet side is divided among the misting nozzle manifolds by utilizing a barbed tee fitting. Therefore, pressurized water flows through multiple water supply lines to the misting nozzle manifolds and through the water atomizing misting nozzles which creates a robust fine mist of atomized water, directed to the upper portion of the occupant(s) operating or riding in an open-air vehicle. Activation of the open-air cooling mist apparatus allows for self-regulation of body temperature and provides cooling of the occupant(s) by utilizing the evaporative cooling effect.

The embodiment of the apparatus utilizes all medical grade components, for proven longevity in the field, and hygienically sound operation.

The precision attachment clamp on water control manifold and misting nozzle manifold(s) may be sized and configured to accommodate various size round stock, square stock or extruded metals in assorted sizes.

The open air vehicle occupant cooling mist apparatus may also include a drinking nozzle connected to the main water supply line between the remote water reservoir and the water control manifold, for individual hydration of the occupant(s). Comprising of a

$$\frac{1}{8} ″ \times \frac{1}{8} ″ \times \frac{1}{8} ″$$

o.d. barbed tee fitting, a drinking nozzle water supply line, and a drinking nozzle.

The remote water reservoir may be pressurized by a compressed gas source located in the screw on lid of the remote water reservoir

The remote water reservoir may be sized accordingly either larger or smaller to accommodate various open-air vehicles and their remote water reservoir location availability.

The precision attached water control manifold and misting nozzle manifold(s) may be manufactured through various manufacturing processes, and materials (i.e., machined billet aluminum, machinable plastics, thermal plastic injection molding and 3D printed.

### BRIEF DESCRIPTION OF THE DRAWINGS

Embodiments are illustrated by way of example and not limitation in the figures in the accompanying drawings, in which:

FIG. 1. is a front view of the preferred embodiment of the open-air vehicle occupant cooling mist apparatus mounted to the handlebars of a motorcycle.

FIG. 2. is a front left side operational view of the water control manifold and one misting nozzle manifold. Featuring the ease of operation utilizing the left thumb to activate the preferred embodiment of the open-air vehicle cooling mist apparatus.

FIG. 3. is a left side view of a motorcycle demonstration typical air flow in front of the motorcycle during operation. A demonstration of atomized water mist flow pattern directed to the upper portion of the motorcycle operator during operation. Example of the remote water reservoir mounted to the frame of the motorcycle.

FIG. 4. is a left side top view of the preferred embodiment of the open-air vehicle occupant cooling mist apparatus. Displaying the remote water reservoirs components, water supply lines, water control manifold, misting nozzle manifolds, and components.

FIG. 5. is a right side top exploded view of the preferred embodiments water control manifold, and the misting nozzle manifolds and their components.

FIG. 6. is a top back view of the water control manifold main water supply line barbed inlet side, the barbed outlet side. And the misting nozzle manifolds barbed inlet side.

FIG. 7. is a front view of the multi-function 32 oz BPA free remote water reservoir and its components. The barbed screw on cap attachment is used when the reservoir is being operated as an open-air vehicle occupant cooling mist apparatus.

### DETAILED DESCRIPTION OF THE INVENTION

Detailed descriptions of the preferred embodiment are provided herein. Specific details disclosed herein are not to be interpreted as limiting, but rather as a basis for the claims and as a representative basis for teaching one skilled in the art to employ the present invention.

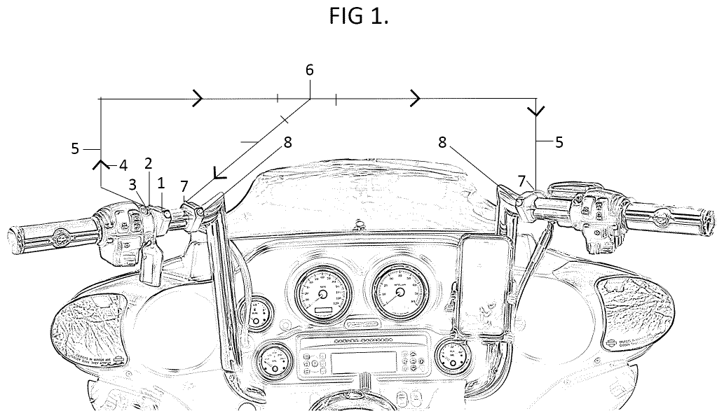

Referring to FIG. 1 front side view of the preferred embodiment mounted to the motorcycle's handlebars. water control manifold with integral normally closed, manually operated, momentary, push button, on-off, 18-8 stainless steel and brass o-ringed water control valve 1. water control manifolds main water supply line integral

$$\frac{1}{16} ″$$

o.d. barbed inlet side location 2. water control manifolds integral

$$\frac{1}{16} ″$$

o.d. barbed outlet side location 3. pressurized water flow diagram displaying flow direction from the water control manifold 4.

$$\frac{1}{16} ″$$

i.d. water supply line to the

$${\frac{1}{16}}^{″} \times {\frac{1}{16}}^{″} \times {\frac{1}{16}}^{″}$$

o.d. barbed brass plated tee fitting 5.

$${\frac{1}{16}}^{″} \times {\frac{1}{16}}^{″} \times {\frac{1}{16}}^{″}$$

o.d. barbed brass plated tee fitting, dividing pressurized water flow through the

$$\frac{1}{16} ″$$

i.d. water supply lines to the integral

$$\frac{1}{16} ″$$

o.d. barbed inlet to the misting nozzle manifolds 6. water supply line(s) integral

$$\frac{1}{16} ″$$

o.d. barbed inlet to the misting nozzle manifolds 7. misting nozzle manifold with integral

$$\frac{3}{250} ″$$

orifice

$$\frac{10}{24} ″$$

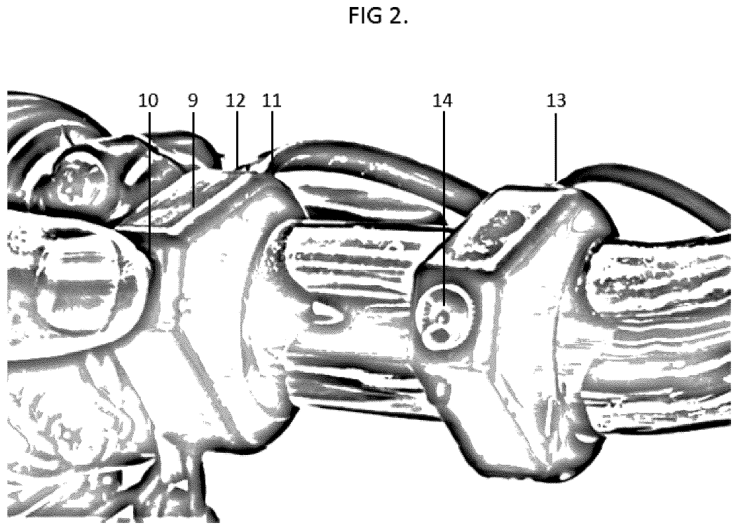

unc 18-8 stainless steel screw in atomizing misting nozzles 8. Referring to FIG. 2. front left side operational view of the preferred embodiment. water control manifold with female side precision attachment incorporated 9. integral normally closed, manually operated, momentary, push button on-off 18-8 stainless steel and brass o-ringed water control valve 10. water control manifold main water supply line integral

$$\frac{1}{16} ″$$

o.d. barbed inlet side location 11. water control manifolds integral

$$\frac{1}{16} ″$$

o.d. barbed outlet side location 12. misting nozzle manifolds integral

$$\frac{1}{16} ″$$

o.d. barbed inlet side location 13. misting nozzle manifold with integral

$$\frac{3}{250} ″$$

orifice

$$\frac{10}{24} ″$$

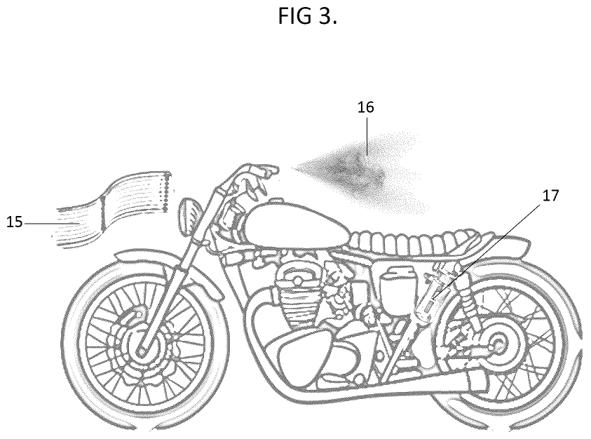

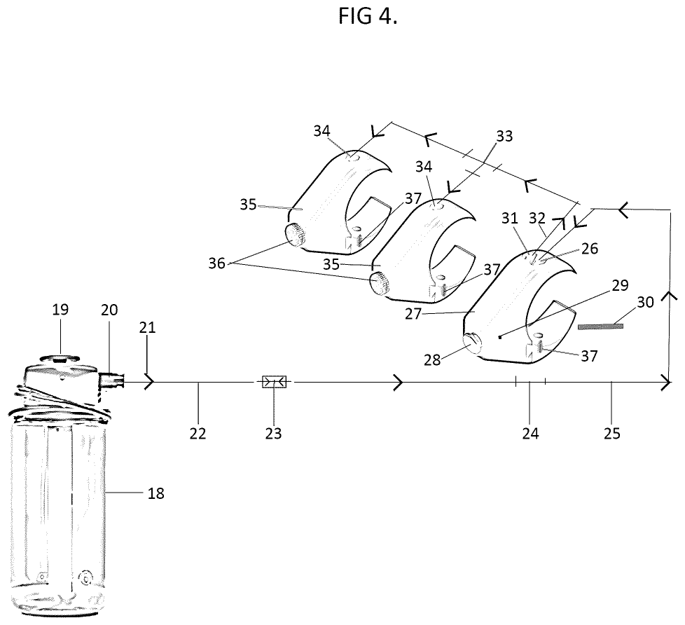

unc 18-8 stainless steel screw in water atomizing misting nozzle 14. Referring to FIG. 3. left side view of a motorcycle. demonstration of typical air flow in front of a motorcycle during operation 15. demonstration of atomized water flow mist pattern directed to the upper portion of the motorcycle operator area during operation 16. multi-function 32 oz BPA free remote water reservoir example of being mounted to the frame of the motorcycle 17. Referring to FIG. 4. Left side view shown are the primary components of the preferred embodiment removed from the open air vehicle. multi-function 32 oz BPA free remote water reservoir 18.

$$2 {\frac{87}{1000}}^{″}$$

i.d. screw on water reservoir lid with integral manually operated mechanical piston type gas (e.g. air) pressurization pump 19. 32 oz BPA free remote water reservoirs main water supply line

$$\frac{1}{8} ″$$

o.d. barbed cap outlet incorporated into the screw on cap attachment 20. diagram of pressurized water flow from the outlet side of the multi-function 32 oz BPA free remote water reservoir 21. main water supply line from the

$$\frac{1}{8} ″$$

o.d. barbed cap outlet side of the 32 oz BPA free remote water reservoir to the

$${\frac{1}{8}}^{″} \times {\frac{1}{8}}^{″}$$

o.d. barbed brass plated exhausting quick release coupling 22.

$${\frac{1}{8}}^{″} \times {\frac{1}{8}}^{″}$$

o.d. barbed brass plated exhausting quick release coupling 23.

$${\frac{1}{8}}^{″} \times {\frac{1}{16}}^{″}$$

o.d. barbed reducing coupling 24.

$$\frac{1}{16} ″$$

i.d. reduced main water supply line from the

$$\frac{1}{16} ″$$

o.d. barbed brass plated reducing coupling to the

$$\frac{1}{16} ″$$

o.d. integral barbed inlet side of the water control manifold 25. water control manifolds main water supply line integral

$$\frac{1}{16} ″$$

o.d. barbed inlet side 26. water control manifold with female side precision attachment incorporated 27. Integral normally closed, manually operated, momentary, push button on-off 18-8 stainless steel and brass o-ringed water control valve 28. Water control valve retaining pin

$${\frac{1}{16}}^{″} \times {\frac{9}{16}}^{″}$$

opening through the water control manifold 29. push in

$${\frac{1}{16}}^{″} \times {\frac{9}{16}}^{″}$$

18-8 stainless steel water control valve retaining pin 30. Water control manifolds integral

$$\frac{1}{16} ″$$

o.d. barbed outlet side 31.

$$\frac{1}{16} ″$$

i.d. water supply line to the

$${\frac{1}{16}}^{″} \times {\frac{1}{16}}^{″} \times {\frac{1}{16}}^{″}$$

o.d. barbed brass plated barbed tee fitting 32.

$${\frac{1}{16}}^{″} \times {\frac{1}{16}}^{″} \times {\frac{1}{16}}^{″}$$

o.d. barbed brass plated tee fitting dividing pressurized water flow through the

$$\frac{1}{16} ″$$

i.d. water supply lines to the misting nozzle manifolds

$$\frac{1}{16} ″$$

o.d. barbed inlet 33. misting nozzle manifolds water supply line integral

$$\frac{1}{16} ″$$

o.d. barbed inlet location 34. misting nozzle manifolds with female side precision attachment incorporated 35.

$$\frac{3}{250} ″$$

orifice

$$\frac{10}{24} ″$$

unc 18-8 stainless steel screw in water atomizing misting nozzles 36. male side precision attachment interlocking clamping device

$$\frac{8}{32} ″$$

thread ×

$$\frac{1}{25} ″$$

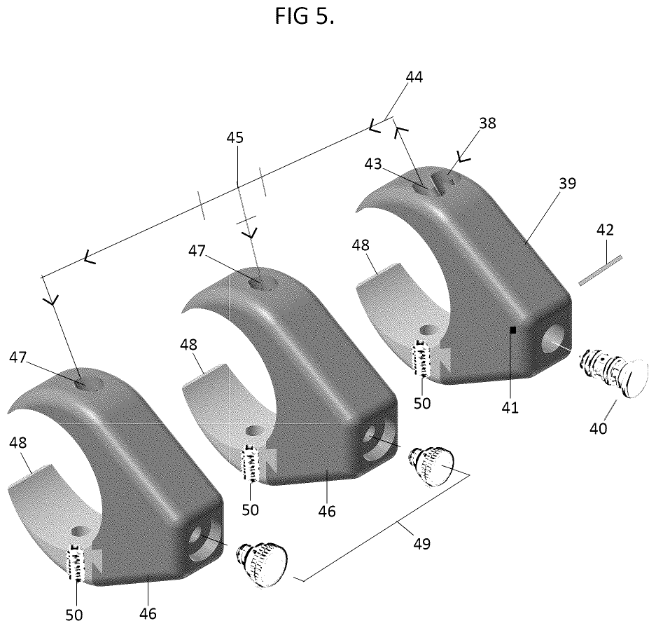

unc 18-8 stainless steel nylon tipped set screw 37. Referring to FIG. 5 right side view of the preferred embodiments water control manifold and misting nozzle manifolds. the water control manifolds main water supply line integral

$$\frac{1}{16} ″$$

o.d. barbed inlet side 38. water control manifold with female side precision attachment incorporated 39. integral normally closed, manually operated, momentary, push button, on-off 18-8 stainless steel and brass o-ringed water control valve 40. Water control valve retaining pin

$${\frac{1}{16}}^{″} \times {\frac{9}{16}}^{″}$$

opening through the water control manifold 41. push in

$${\frac{1}{16}}^{″} \times {\frac{9}{16}}^{″}$$

18-8 stainless steel water control valve retaining pin 42. water control manifolds

$$\frac{1}{16} ″$$

o.d. barbed outlet side location 43. diagram of pressurized water flow from the water control manifolds outlet side to the

$${\frac{1}{16}}^{″} \times {\frac{1}{16}}^{″} \times {\frac{1}{16}}^{″}$$

o.d. barbed brass plated tee fitting 44.

$${\frac{1}{16}}^{″} \times {\frac{1}{16}}^{″} \times {\frac{1}{16}}^{″}$$

o.d. barbed brass plated tee fitting dividing pressurized water through the

$$\frac{1}{16} ″$$

i.d. water supply lines to the misting nozzle manifolds integral

$$\frac{1}{16} ″$$

o.d. barbed inlet 45. misting nozzle manifolds with female side precision attachment incorporated 46. misting nozzle manifolds water supply line with integral

$$\frac{1}{16} ″$$

o.d. barbed inlet location 47. male side of the precision attachment interlocking clamping device to the female side incorporated into the manifolds 48.

$$\frac{3}{250} ″$$

orifice

$$\frac{10}{24} ″$$

unc, 18-8 stainless steel, water atomizing misting nozzles 49. male side of the precision attachment interlocking clamping devices

$$\frac{8}{32} ″$$

thread ×

$${\frac{1}{25}}^{″}$$

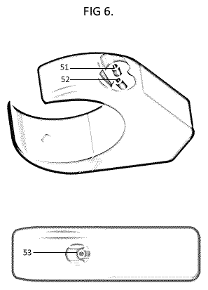

unc, 18-8 stainless steel nylon tipped set screws 50. Referring to FIG. 6. Top back side view of the water control manifolds integral barbed main water supply line inlet side, the integral barbed water supply line outlet side. And the misting nozzle(s) integral barbed inlet. water control manifold main water supply line integral

$${\frac{1}{16}}^{″}$$

o.d. barbed inlet side 51. water control manifolds water supply line integral

$${\frac{1}{16}}^{″}$$

o.d. barbed outlet side 52. Misting nozzle manifolds water supply line integral

$${\frac{1}{16}}^{″}$$

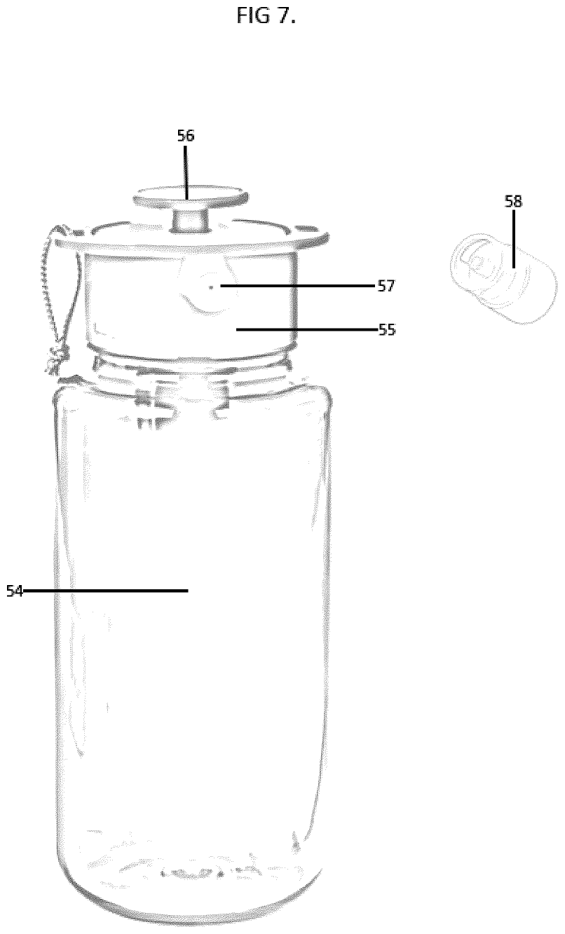

o.d. barbed inlet 53. Referring to FIG. 7. multi-function 32 oz BPA free remote multi-function water reservoir and its components. multi-function, 32 oz BPA free remote water reservoir 54.

$$2 {\frac{87}{1000}}^{″}$$

i.d. multi-function 32 oz remote water reservoirs screw on lid 55. 32 oz BPA free remote water reservoirs manually operated piston type gas (e.g. air) pressurization pump, incorporated into the screw on lid 56. outlet side of the multi-function 32 oz BPA free remote water reservoir with personal misting nozzle attached 57. screw on open-air vehicle reservoir barbed cap attachment with integral

$${\frac{1}{8}}^{″}$$

o.d. barbed fitting, for attachment to the outlet side of the multi-function 32 oz BPA free remote water reservoir 58.

### DRAWINGS REFERENCE NUMBERS

FIG. 1: Front side view of the preferred embodiment mounted on a motorcycle's handlebars
1. Water control manifold with integral, normally closed, manually operated, momentary, push button on-off 18-8 stainless steel and brass o-ringed water control valve
2. Water control manifold main water supply line integral

$${\frac{1}{16}}^{″}$$

o.d. barbed inlet side location
3. Water control manifold integral

$${\frac{1}{16}}^{″}$$

o.d. barbed outlet side location
4. Pressurized water flow diagram, displaying flow direction from the water control manifold
5.

$${\frac{1}{16}}^{″}$$

i.d. water supply line(s) to the

$${\frac{1}{16}}^{″} \times {\frac{1}{16}}^{″} \times {\frac{1}{16}}^{″}$$

o.d. brass plated barbed tee fitting
6.

$${\frac{1}{16}}^{″} \times {\frac{1}{16}}^{″} \times {\frac{1}{16}}^{″}$$

o.d. brass plated barbed tee fitting, dividing pressurized water flow through the

$${\frac{1}{16}}^{″}$$

i.d. water supply lines to the integral

$${\frac{1}{16}}^{″}$$

o.d. barbed inlet of the misting nozzle manifolds
7. Water supply line(s) integral

$${\frac{1}{16}}^{″}$$

o.d. barbed inlet to misting nozzle manifolds
8. Misting nozzle manifold with integral

$${\frac{3}{250}}^{″}$$

orifice

$${\frac{10}{24}}^{″}$$

unc 18-8 stainless steel screw in water atomizing misting nozzle

FIG. 2: Front left side operational view of the preferred embodiment
9. Water control manifold with female side precision attachment incorporated
10. Integral normally closed, manually operated, momentary, push button on-off 18-8 stainless steel and brass o-ringed water control valve
11. Water control manifolds main water supply line integral

$${\frac{1}{16}}^{″}$$

o.d. barbed inlet side location
12. Water control manifolds integral

$${\frac{1}{16}}^{″}$$

o.d. barbed water supply outlet side location
13. Misting nozzle manifold integral

$$\frac{1}{16} ″$$

o.d. barbed water supply inlet side location
14. Misting nozzle manifold with integral

$$\frac{3}{250} ″$$

orifice

$$\frac{10}{24} ″$$

unc 18-8 stainless steel, screw in, water atomizing misting nozzle

FIG. 3: Left side view of a motorcycle
15. Demonstration of typical air flow in front of the motorcycle during operation
16. Demonstration of atomized water flow mist pattern directed to the upper portion of the motorcycle operator during operation
17. Multi-function 32 oz BPA free remote water reservoir example of being example of mounting to the frame of the motorcycle

FIG. 4: Is a left side view of the primary components of the preferred embodiment removed from the open-air vehicle
18. Multi-function 32 oz BPA free remote water reservoir
19.

$$2 {\frac{87}{1000}}^{″}$$

i.d. screw on water reservoir lid with integral manually operated, mechanical piston type gas (e.g. air) pressurization pump
20. Multi-function 32 oz BPA free remote water reservoirs main water supply line

$$\frac{1}{8} ″$$

o.d. barbed cap outlet incorporated into the screw on cap attachment
21. Diagram of pressurized water flow from the outlet side of the multi-function 32 oz BPA free remote water reservoir
22. Main water supply line from the

$$\frac{1}{8} ″$$

o.d. barbed cap outlet side of the multi-function BPA free remote water reservoir to the

$${\frac{1}{8}}^{″} \times {\frac{1}{8}}^{″}$$

barbed brass plated exhausting quick release coupling
23.

$${\frac{1}{8}}^{″} \times {\frac{1}{8}}^{″}$$

o.d. barbed brass plated exhausting barbed quick release coupling
24.

$${\frac{1}{8}}^{″} \times {\frac{1}{16}}^{″}$$

o.d barbed brass plated reducing coupling
25.

$${\frac{1}{16}}^{″}$$

i.d. reduced main water supply line from the

$$\frac{1}{16} ″$$

o.d. barbed brass plated reducing coupling to the

$$\frac{1}{16} ″$$

o.d. integral barbed inlet side of the water control manifold
26. Water control manifolds main water supply line integral

$$\frac{1}{16} ″$$

o.d. barbed inlet side
27. Water control manifold with female side precision attachment incorporated
28. Integral normally closed, manually operated, momentary, push button on-off 18-8 stainless steel and brass o-ringed water control valve
29. Water control valve retaining pin

$${\frac{1}{16}}^{″} \times {\frac{9}{16}}^{″}$$

opening through the water control manifold
30. Push in

$${\frac{1}{16}}^{″} \times {\frac{9}{16}}^{″}$$

18-8 stainless steel water control valve retaining pin
31. Water control manifolds water supply line integral

$$\frac{1}{16} ″$$

o.d. barbed outlet side
32.

$$\frac{1}{16} ″$$

i.d. water supply line to the

$${\frac{1}{16}}^{″} \times {\frac{1}{16}}^{″} \times {\frac{1}{16}}^{″}$$

o.d. barbed brass plated tee fitting
33.

$${\frac{1}{16}}^{″} \times {\frac{1}{16}}^{″} \times {\frac{1}{16}}^{″}$$

o.d. barbed brass plated tee fitting dividing pressurized water flow though the

$$\frac{1}{16} ″$$

i.d. water supply lines to the misting nozzle manifolds integral

$$\frac{1}{16} ″$$

o.d. barbed inlet
34. Misting nozzle manifolds water supply line integral

$$\frac{1}{16} ″$$

o.d. barbed inlet location
35. Misting nozzle manifolds with female side precision attachment incorporated
36.

$$\frac{3}{250} ″$$

orifice

$$\frac{10}{24} ″$$

unc 18-8 stainless steel, screw in water atomizing misting nozzles
37. Male side precision attachment interlocking clamping device

$$\frac{8}{32} ″$$

thread ×

$$\frac{1}{25} ″$$

unc 18-8 stainless steel nylon tipped set screw

FIG. 5: Right side exploded view of the preferred embodiments water control manifold and misting nozzle manifolds
38. Water control manifolds main water supply line integral

$$\frac{1}{16} ″$$

o.d. barbed inlet side
39. Water control manifold with female side precision attachment incorporated
40. Integral normally closed, manually operated, momentary, push button, on-off, 18-8 stainless steel and brass o-ringed water control valve
41. Water control valve retaining pin

$${\frac{1}{16}}^{″} \times {\frac{9}{16}}^{″}$$

opening through the water control manifold
42. Push in

$${\frac{1}{16}}^{″} \times {\frac{9}{16}}^{″}$$

18-8 stainless steel water control valve retaining pin
43. Water control manifolds

$$\frac{1}{16} ″$$

o.d. barbed outlet side location
44. Diagram of pressurized water flow from the water control manifolds outlet side to the

$${\frac{1}{16}}^{″} \times {\frac{1}{16}}^{″} \times {\frac{1}{16}}^{″}$$

o.d. barbed brass plated tee fitting
45.

$${\frac{1}{16}}^{″} \times {\frac{1}{16}}^{″} \times {\frac{1}{16}}^{″}$$

o.d. barbed, brass plated tee fitting dividing pressurized water through the integral

$$\frac{1}{16} ″$$

i.d. water supply lines to the misting nozzle manifolds integral

$$\frac{1}{16} ″$$

o.d. barbed inlet
46. Misting nozzle manifolds with integral female precision attachment incorporated
47. Misting nozzle manifolds water supply line with integral

$$\frac{1}{16} ″$$

o.d. barbed inlet location
48. Male side of the precision attachment interlocking clamping device to the female side incorporated into the manifolds
49.

$$\frac{3}{250} ″$$

orifice

$$\frac{10}{24} ″$$

unc 18-8 stainless steel water atomizing misting nozzles
50. Male side of the precision attachment interlocking clamping devices

$$\frac{8}{32} ″$$

thread ×

$$\frac{1}{25} ″$$

unc 18-8 stainless steel nylon tipped set screws

FIG. 6: Top back side view of the water control manifolds integral barbed main water supply line inlet side and the integral barbed water supply line outlet side. And the misting nozzle(s) integral barbed inlet
51. Water control manifold main water supply line integral

$$\frac{1}{16} ″$$

o.d. barbed inlet side
52. Water control manifolds water supply line integral

$$\frac{1}{16} ″$$

o.d. barbed outlet side
53. Misting nozzle manifolds water supply line integral

$$\frac{1}{16} ″$$

o.d. barbed inlet

FIG. 7: Multi-function 32 oz BPA free remote multi-function water reservoir and components
54. Multi-function 32 oz BPA free remote water reservoir
55.

$$2 {\frac{87}{1000}}^{″}$$

i.d. multi-function 32 oz remote water reservoirs screw on lid
56. Multi-function 32 oz BPA free remote water reservoirs manually operated piston type gas (e.g. air) pressurization pump incorporated into the screw on lid
57. Outlet side of the multi-function 32 oz BPA free remote water reservoir with personal misting nozzle cap attached
58. Barbed screw on water reservoir cap attachment with integral

$$\frac{1}{8} ″$$

o.d. barbed fitting for attachment to the outlet side of the multi-function 32 oz BPA free remote water reservoir

1. The open air occupant vehicle cooling mist apparatus consists of a clamp on water control manifold, clamp on misting nozzle manifold(s), and their integral components.

2. The open air occupant cooling mist apparatus is manually operated.

3. The open air vehicle cooling mist apparatus utilizes atomized water for the subsequent evaporative cooling effect.

4. The open air occupant cooling mist apparatus's water control manifold and misting nozzle manifold(s) consist of a “bird beak” open back design configured to be attached to the open-air vehicle.

5. The precision attachment interlocking clamping device is comprised of a separate male end, and female end that is designed to interlock, the female side is configured into the water control manifold and the misting nozzle manifolds.

6. The misting apparatuses water control manifold and misting nozzle manifolds precision attachment interlocking clamping device may be designed to mount to a variety open air vehicle locations.

7. The water control manifold and misting nozzle manifold(s) may include being designed to accommodate round stock, square stock, and other geometries.

8. A refillable remote water reservoir may include a component that pressurizes the remote water reservoir.

9. The multi-function remote water reservoir may include being sized accordingly, either larger or smaller to accommodate various open-air vehicle's remote location availability.

10. The open air vehicle cooling mist apparatus may include a remote drinking nozzle, for the purpose of individual hydration while operating an open-air vehicle.
